(19) United States
(12) Patent Application Publication
(10) Pub. No.: US 2008/0244219 A1
(43) Pub. Date: Oct. 2, 2008

(54) METHOD AND APPARATUS FOR CONTROLLING A SINGLE-USER APPLICATION IN A MULTI-USER OPERATING SYSTEM

(76) Inventor: HIDETO KOBAYASHI, Tokyo (JP)

Correspondence Address: Jackson Chen;NEC Corporation of America, 6535 N. State Hwy. 161, Irving, TX, 75039, US

(21) Appl. No.: 12/049,121

(22) Filed: Mar. 14, 2008

(30) Foreign Application Priority Data
Mar. 26, 2007 (JP) 2007-079809

(51) Int. Cl. G06F 12/00

(52) U.S. Cl. 711/210; 711/E12.001

(57) ABSTRACT

A control system enables a plurality of users to execute a single-user application simultaneously in a multi-user OS which causes address conflicts under simultaneous execution and save results for each user avoiding the address conflicts. The control system comprises a control unit 10 which changes write addresses of applications 51-53 which cause address conflicts under simultaneous execution in a multi-user OS from original addresses specific to each application to a mapped address in a subordinate directory of any of user profile directories 61, 62 specific to each user who runs the application(s) 51-53.

### REFERENCE TO RELATED APPLICATION

This application is based upon and claims the benefit of the priority of Japanese patent application No. 2007-079809, filed on Mar. 26, 2007, the disclosure of which is incorporated herein in its entirety by reference thereto.

### FIELD OF THE INVENTION

The present invention relates to a method and system for controlling a plurality of single user programs in a multi-user operating system.

### BACKGROUND OF THE INVENTION

A multi-user operating system (OS) enables a plurality of users to use simultaneously a single computer.

A multi-user application employs user profiles registered each for each user to manage each piece of information set for each user (termed “user contexts”) in the multi-user OS. Therefore, the multi-user application can write to and read from a user profile (directory) for the user who is running the application.

However, a single-user application which is not supposed to be executed simultaneously by a plurality of users and does not recognize the user profile writes to and reads from a single profile.

Therefore, when a single-user application is executed simultaneously by a plurality of users on a computer under a multi-user OS, a plurality of instances of the application attempt to write to and read from a same single file stored at a single address.

Application Isolation Environment in Citrix Presentation Server (Citrix Systems, Inc.) under Windows OS (Microsoft Corp, Redmond, Wash.) is known, for example, as an environment where a plurality of users can execute a single-user application under a multi-user OS (Patent Document 1). In this environment, a method comprising the steps of copying (storing) an execution file of the application in a subordinate directory of the user profile and obtaining the data there from is employed.

Also, there is known a method for enabling a plurality of users to execute simultaneously a single-user application program in a multi-user OS environment without conflicts of the address, disclosed in Patent Document 2. The method comprises: allocating a unique identifier to each user who executes a single-user application program; and assigning the unique identifier to an object created by execution of the application program.

### [Patent Document 1]

Japanese Patent Kohyo Publication No. JP-P2000-505575A

### [Patent Document 2]

Japanese Patent Kohyo Publication No. JP-A-11-513822

### SUMMARY OF THE DISCLOSURE

The following analysis is given by the present invention.

The entire disclosure of Patent Documents 1 and 2 are incorporated herein by reference thereto.

In the method disclosed in Patent Document 2, single-user applications which cause address conflicts when executed simultaneously by a plurality of users are not distinguished from single-user applications which do not cause the address conflicts.

Namely, there is a problem in the method that even in case of a single-user application which needs not to identify a user (i.e., to be associated with a unique identifier), it reads from and writes to a unique directory for the user.

Therefore, it is an object of the present invention to provide a method and system for enabling a plurality of users to execute a single-user application simultaneously in a multi-user OS without address conflicts under simultaneous execution so as to enable writing different information per each user, only for an application which would cause address conflicts. Other objects will become apparent in the entire disclosure.

According to a first aspect of the present invention, there is provided a control system comprising: a control unit that changes write addresses of applications which cause address conflicts when executed simultaneously by a plurality of users in a multi-user operation system OS from an original address specific to each of the applications to a mapped address specific for each user.

In the first aspect, there is also provided a control system further comprising an application table storing application identifiers for the applications, wherein the control unit refers to the application table.

In the first aspect, there is also provided a control system wherein the mapped address is a file in a subordinate directory of a user profile directory.

In the first aspect, there is also provided a control system further comprising an address mapping table storing records each provided with a user identifiers, the original address, and the mapped address. The control unit determines whether the record of a user identifier and an original address is stored in the address mapping table. It changes a write address from the original address to a mapped address stored in the address mapping table, if there is a coincident record of the user identifier and the original address stored in the address mapping table; whereas it changes the write address from the original address to a newly defined mapped address and stores the newly defined mapped address together with the user identifier and the original address to the address mapping table, if there is no coincident record of the user identifier and the original address stored in the address mapping table.

In the first aspect, there is also provided a control system wherein the control unit changes the read address from an original address to a mapped address stored in the address mapping table, if there is a coincident record of the user identifier and the original address stored in the address mapping table upon referring to the address mapping table.

According to a second aspect of the present invention, there is provided a control method comprising: changing write addresses of applications which cause address conflicts when executed simultaneously by a plurality of users, in a multi-user OS, from an original address specific to each application to a mapped address specific for each user.

In the second aspect, there is also provided a control method, wherein the changing write addresses further comprises: utilizing an application table which stores application identifiers (each) for (each of) the applications.

In the second aspect, there is also provided a control method, wherein the mapped address is a file in a subordinate directory of a user profile directory.

In the second aspect, there is also provided a control method, further comprising, in changing the write address: referring to an address mapping table that stores records each provided with a user identifier, the original address, and the mapped address; changing the write address from the original address to the mapped address stored in the address mapping table, if there is a coincident record of the user identifier and the original address stored in the address mapping table; and changing the write address from the original address to a newly defined mapped address and stores the newly defined mapped address together with the user identifier and the original address to the address mapping table if there is no coincident record of the user identifier and the original address stored in the address mapping table.

In the second aspect, there is also provided a control method further comprising: changing the read address of the application from an original address to a mapped address stored in the address mapping table if there is a coincident record of the user identifier and the original address stored in the address mapping table.

The meritorious effects of the present invention are summarized as follows.

The method and system according to the present invention enable a plurality of users to execute a single-user application simultaneously in a multi-user OS, only in such a case of an application that might cause address conflicts, under simultaneous execution in the OS so as to enable writing respective different information for each user without the address conflicts.

Moreover, the method and system according to the present invention enable each user to read a piece of information each written for each user by a single-user application avoiding the address conflicts.

### BRIEF DESCRIPTIONS OF THE DRAWINGS

FIG. 1 shows a block diagram of a single-user application control system according to an exemplary embodiment of the present invention.

FIG. 2 shows a flow diagram of a write operation in a single-user application control system according to an exemplary embodiment of the present invention.

FIG. 3 shows a flow diagram of a read operation in a single-user application control system according to an exemplary embodiment of the present invention.

FIG. 4 shows an example of an address mapping table 40 in FIG. 1.

FIG. 5 shows an example of an application table in FIG. 1.

### PREFERRED MODES OF THE INVENTION

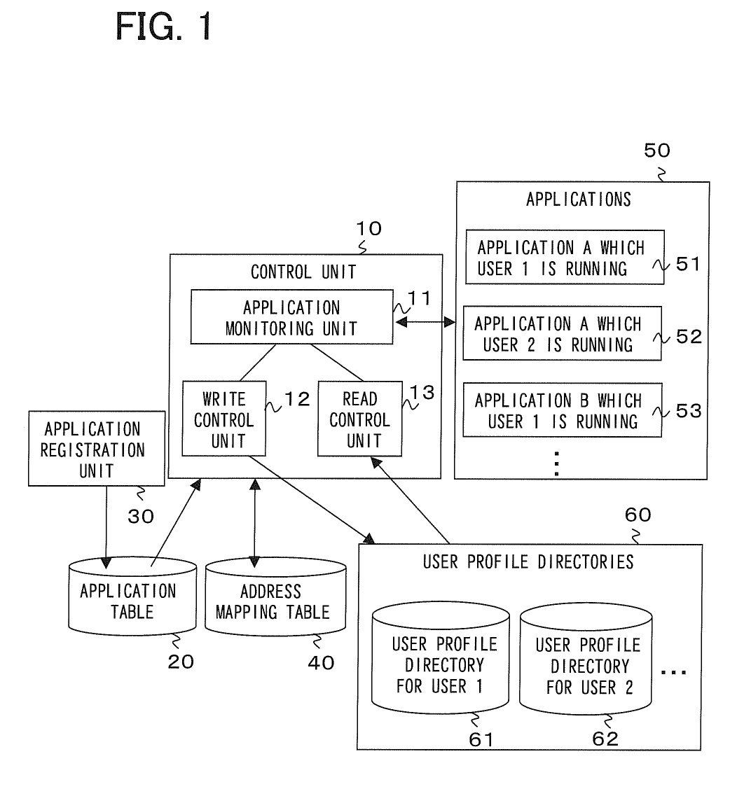

A preferred mode of the present invention is described with reference to the accompanying drawings. A control system according to an exemplary embodiment of the present invention is described with reference to FIG. 1.

The control system comprises a control unit 10, an application table 20, an application registration unit 30, an address mapping table 40, a group of applications 50 executed by a plurality of users, and a group of user profile directories 60 each of which is unique to each user.

The control unit 10 monitors application interfaces for the applications 50 and controls read and write operations of the applications 50.

The control unit 10 comprises an application monitoring unit 11, a write control unit 12, and a read control unit 13. The application monitoring unit 11 monitors the application interfaces for the group of applications 50. The write control unit 12 controls the write operations of the applications 50. The read control unit 13 controls the read operation of the applications 50.

The application table 20 stores a list of the applications 50 that should be monitored by the control unit 10. The application registration unit 30 registers the applications 50 in a list stored in the application table 20.

The address mapping table 40 stores user identifiers, original addresses, and mapped address.

If the application monitoring unit 11 detects a request for a write operation from an application whose identifier is stored in the application table 20, the write control unit 12 stores the user identifier, the original address, and the mapped address to the address mapping table 40.

The mapped address is created by creating any directing in the group of user profile directories 60, being added with an original address.

The write control unit 12 stores the content of the original address to the mapped address in a subdirectory in the group of user profile directories 60.

If the original address is C:¥temp¥data¥setting.ini for example, the content of C$¥temp¥data¥setting.ini is added to a subordinate directory (subdirectory) of anyone of the user profile directories 60.

If the application monitoring unit 11 detects a request for a read operation from an application whose identifier is stored in the application table 20, the read control unit 13 changes the read address from the original address to the mapped address employing the address mapping table 40.

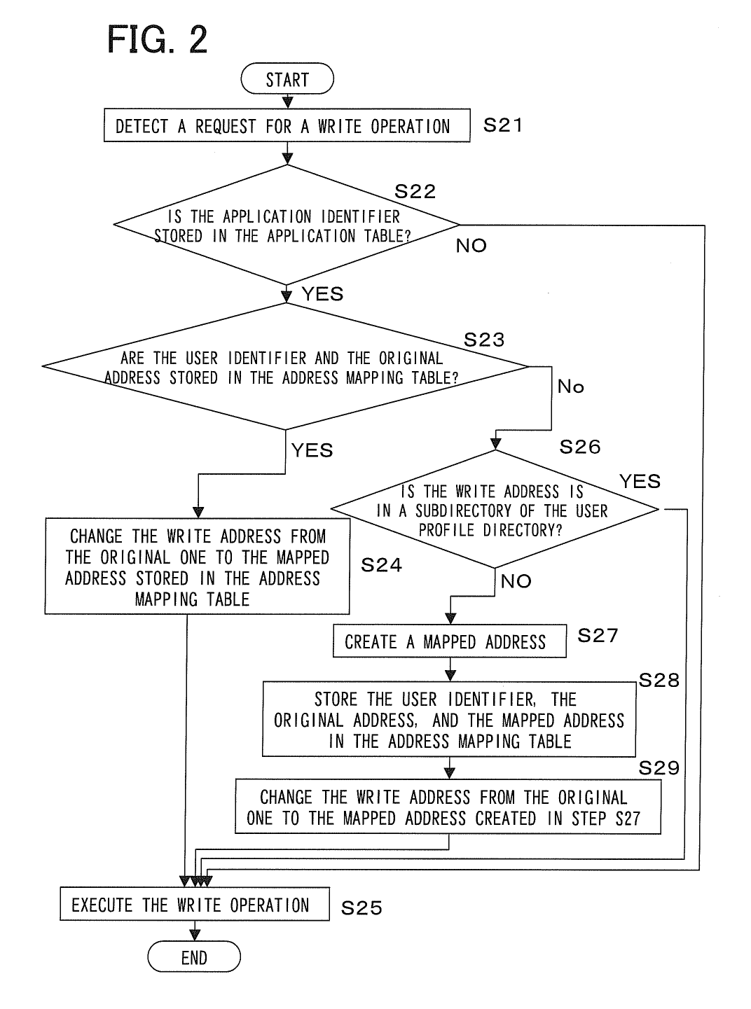

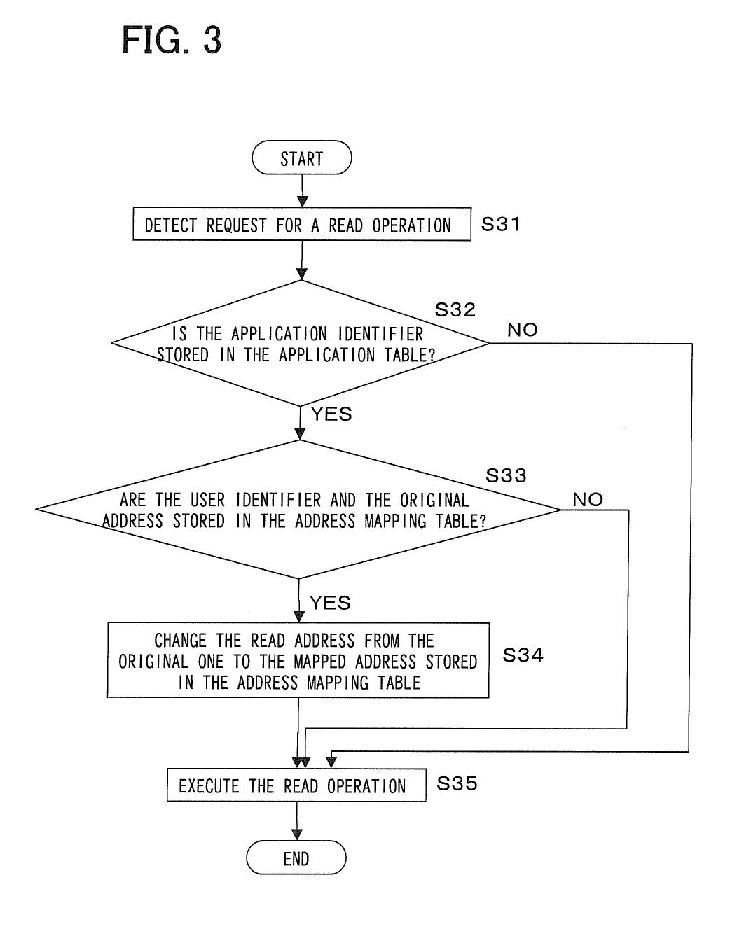

An operation of the control system according to an exemplary embodiment of the present invention is described with reference to a block diagram in FIG. 1 and flow diagrams in FIG. 2 and FIG. 3.

A write operation is described with reference to FIG. 1 and FIG. 2.

The application monitoring unit 11 detects a request for a write operation (Step S21) and determines whether the application identifier is stored in the application table 20 (Step S22).

If the application identifier is not stored in the application table 20, the write control unit 12 allows the write operation without changing the write address (Step S25).

If the application identifier is stored in the application table 20, the write control unit 12 determines whether the user identifier and the original address are stored in the address mapping table 40 (Step S23).

If the user identifier and the original address are not stored in the address mapping table 40, the write control unit 12 obtains the user profile from the OS and determines whether the write address is in a subdirectory of the user profile directory (Step S26).

If the write address is in a subdirectory of the user profile directory, the write control unit 12 allows the write operation without changing the write address (Step S25).

If the write address is not in a subdirectory of the user profile directory, the write control unit 12 creates a mapped address in a subdirectory of the user profile directory and stores the content of the original address to the mapped address (Step S27).

If the original address and the user profile directory are C:¥temp¥data¥setting.ini and C:¥Document and Settings¥USER1 for example, the mapped address is C:¥Document and Settings¥USER1¥Appfolder¥C$¥temp¥data¥setting.ini, where Appfolder denotes an arbitrary directory.

The write control unit 12 stores the user identifier, the original address, and the mapped address to the address mapping table 40 (Step S28).

The write control unit 12 changes the write address from the original address to the mapped address created in Step S27 (Step S29) and executes the write operation (Step S25).

If it is determined that there exists a coincident record at step S23 (i.e., if the user identifier concerned and the original address concerned are stored in the address mapping table 40), the write control unit 11 changes the write address from the original address to the mapped address stored in the address mapping table 40 (Step S24) and allows to execute the write operation (Step S25).

Next, a read operation is described with reference to FIG. 1 and FIG. 3.

If the application monitoring unit 11 detects a request for a read operation (Step S31), the read control unit 13 determines whether the application identifier is stored in the application table 20 (Step S32).

If the application identifier is not stored in the application table 20, the read control unit 13 allows to execute the read operation without changing the read address (Step S35).

If the application identifier is stored in the application table 20, the read control unit 13 determines whether the user identifier concerned and the original address concerned are stored in the address mapping table 40 (Step S33).

If the user identifier and the original address are not stored in the address mapping table 40, the read control unit 13 allows to execute the read operation without changing the read address (Step S35).

If the user identifier and the original address are stored in the address mapping table 40, the read control unit 13 changes the read address from the original address to the mapped address stored in the address mapping table 40 (Step S34) and allows to execute the read operation (Step S35).

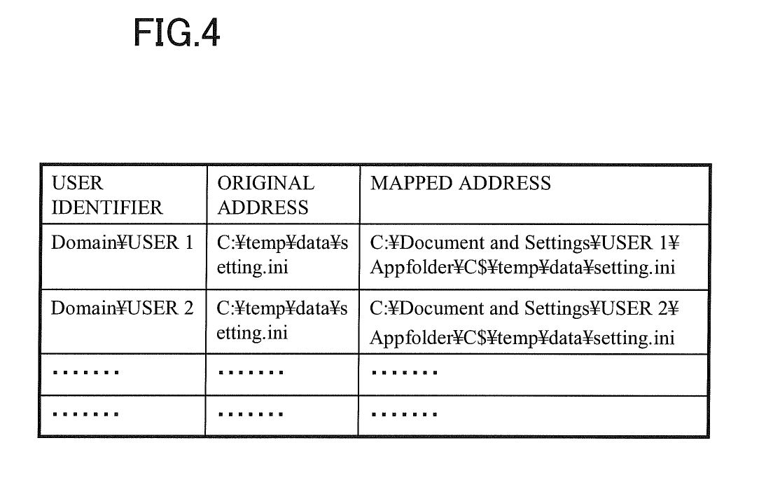

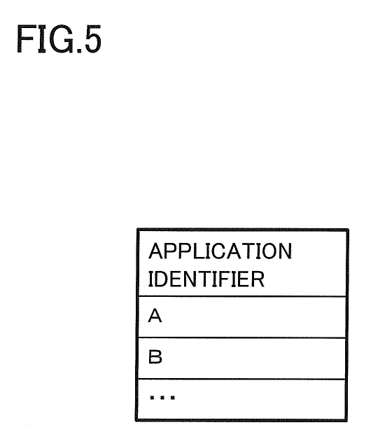

Next, explanation is given in case where a single-user application is executed by a plurality of users, i.e., a write operation for each user is performed in the following manner as exemplified with reference to FIG. 1, FIG. 4, and FIG. 5.

If the application monitoring unit 11 detects a request for a write operation to C:¥temp¥data¥setting.ini from an application A 51 executed by user 1 and the identifier of the application is stored in the application table 20 (See FIG. 5), the write control unit 12 changes the write address to a mapped address (for example C:¥Document and Settings¥USER1¥Appfolder¥C$¥temp¥data¥setting.ini in a subdirectory of a user profile directory 61 for user 1) and allows to execute the write operation. Then the write control unit 12 stores the mapped address to the address mapping table 40.

If the application monitoring unit 11 detects a request for a write operation to C:¥temp¥data¥setting.ini from an application A 52 executed by user 2 and the identifier of the application A 52 is stored in the application table 20, the write control unit 12 changes the write address to a mapped address (for example C:¥Document and Settings¥USER2¥Appfolder¥C$¥temp¥data¥setting.ini in a subdirectory of a user profile directory 62 for user 2) and allows to execute the write operation. Therefore, the system enables to save individual information (result) for each of users 1 and 2, respectively.

Next, an example of data sharing among a plurality of applications is described with reference to FIG. 1.

If the application monitoring unit 11 detects a request for a write operation to C:¥temp¥data¥setting.ini from an application A 51 executed by user 1 and the identifier of the application A 51 is stored in the application table 20, the write control unit 12 changes the write address to a mapped address (for example C:¥Document and Settings¥USER1¥Appfolder¥C$¥temp¥data¥setting.ini in a subdirectory of the user profile directory 61 for user 1) and allows to execute the write operation.

If the application monitoring unit 11 detects a request for a read operation from C:¥temp¥data¥setting.ini from an application B 53 executed by user 1 and the identifier of the application B 53 is stored in the application table 20, the read control unit 13 determines whether the user identifier “USER1” and the original address “C:¥temp␣data¥setting.ini” are stored in the address mapping table 40.

If a coincident record, (i.e., the user identifier concerned and the original address concerned) is stored in the address mapping table 40 as shown in FIG. 4, the read control unit 13 changes the read address from the original address to the mapped address C:¥Document and Settings¥USER1¥Appfolder¥C$¥temp¥data¥setting.ini.

In this way, the application B 53 executed by user 1 can read results written by the application A 51 which user 1 is running, which enables the applications A and B to cooperate each other under mutual individual recognition and communication.

The present invention can be employed in a client-server system where a server executes application programs requested from a plurality of clients connected to the server through a network.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A control system comprising:
a control unit that changes write addresses of applications which cause address conflicts when executed simultaneously by a plurality of users in a multi-user operating system (OS),
said changing being performed from an original address specific to each of said applications to a mapped address specific for each user.

2. The control system as defined in claim 1 further comprising an application table storing application identifiers for the applications, wherein said control unit refers to said application table.

3. The control system as defined in claim 1 wherein the mapped address is a file in a subordinate directory of a user profile directory.

4. The control system as defined in claim 1 further comprising an address mapping table storing records each provided with a user identifier, an original address, and the mapped address;
wherein said control unit determines whether said record of a user identifier and an original address is stored in said address mapping table,
changes a write address from the original address to a mapped address stored in the address mapping table, if there is a coincident record of the user identifier and the original address stored in said address mapping table, and
changes the write address from the original address to a newly defined mapped address and stores this newly defined mapped address together with the user identifier and the original address to said address mapping table if there is no coincident record of the user identifier and the original address stored in said address mapping table.

5. The control system of claim 4, wherein said control unit changes the read address from an original address to a mapped address stored in said address mapping table if there is a coincident record of the user identifier and the original address stored in said address mapping table upon referring to said address mapping table.

6. A control method comprising:
providing a multi-user operating system; and
changing write addresses of applications which cause address conflicts when executed simultaneously by a plurality of users in said multi-user operating system from an original address specific to each application to a mapped address specific for each user.

7. The control method as defined in claim 6, wherein said changing write addresses further comprises: utilizing an application table which stores application identifiers for the applications.

8. The control method as defined in claim 6, wherein the mapped address is a file in a subordinate directory of a user profile directory.

9. The control method as defined in claim 6 further comprising in said changing the write address:
referring to an address mapping table that stores records each provided with a user identifier, the original address, and the mapped address;
changing the write address from the original address to the mapped address stored in the address mapping table, if there is a coincident record of the user identifier and the original address stored in the address mapping table; and
changing the write address from the original address to a newly defined mapped address and stores the newly defined mapped address together with the user identifier and the original address to the address mapping table, if there is no coincident record of the user identifier and the original address stored in the address mapping table.

10. The control method as defined in claim 9 further comprising: changing the read address of said application from an original address to a mapped address stored in the address mapping table, if there is a coincident record of the user identifier and the original address stored in the address mapping table.
